(19) United States
(12) Patent Application Publication
(10) Pub. No.: US 2007/0039053 A1
(43) Pub. Date: Feb. 15, 2007

(54) Security server in the cloud

(75) Inventor: Uzi Dvir, Tel Aviv (IL)

Correspondence Address: DR. MARK M. FRIEDMAN;C/O BILL POLKINGHORN - DISCOVERY DISPATCH, 9003 FLORIN WAY, UPPER MARLBORO, MD, 20772, US

(73) Assignee: Aladdin Knowledge Systems Ltd., Tel Aviv (IL)

(21) Appl. No.: 11/462,046

(22) Filed: Aug. 3, 2006

Related U.S. Application Data
(60) Provisional application No. 60/704,909, filed on Aug. 3, 2005.

(51) Int. Cl. G06F 15/16; G06F 12/14; H04L 9/32; G06F 17/00; G06F 11/30; G06F 9/00; G06F 11/00; G06F 12/16; G06F 15/18; G08B 23/00

(52) U.S. Cl. 726/24; 726/12; 713/188; 726/15

(57) ABSTRACT

Apparatus and methods for providing proxy and security services to one or more users via a publicly accessible network (e.g. the Internet) are disclosed Upon receiving a user request for content residing at a third-party location, a security server(s) retrieves the requested content from the third-party location, and monitors the retrieved content for suspected malicious code, which may be removed from the retrieved content before serving to the user. According to exemplary embodiments, the security server(s) is further operative to route value-added content to the user, for example, value-added content retrieved from various network sources. In some embodiments, this value-added content is associated with the request content from the third-party location. Exemplary value-added content includes but is not limited to advertisements (e.g. targeted advertisements), sponsored links, additional content mark-up, etc. Although the presently-disclosed service may be provided to any user, in exemplary embodiments, the service is provide selectively to pre-registered and/or authenticated subscribed users.

### CROSS-REFERENCE TO RELATED APPLICATIONS

This patent application claims the benefit of U.S. Provisional Patent Application No. 60/704,909 filed Aug. 3, 2005 by the present inventor.

### FIELD OF THE INVENTION

The present invention relates to apparatus and methods for providing protection against suspected malicious code transmitted over a public networks such as the Internet.

### BACKGROUND OF THE INVENTION

Distribution of Malicious Code Over the Internet

With the growth of the Internet, the increased use of computers and the exchange of information between individual users poses a threat to the security of computers. Among the various security threats that present increasingly difficult challenges to the secure operation of computer systems are computer viruses, worms, Trojan horses, etc. Computer viruses are programs that can infect other programs by modifying them in such a way as to include a copy of themselves. Unlike computer viruses, worms do not need to infect other programs. Worms are independent programs that are capable of reproducing themselves, spreading from machine to machine across network connections, often via email.

A Trojan horse may be an executable program that appears to be desirable but is merely disguised as “friendly” and actually contains harmful code, allowing an attacker to come in through a “back door” and perform malicious actions on the computer system. Trojans prey on system vulnerabilities and may be extremely destructive, allowing attackers to monitor, administer, and/or perform any action on a computer system that the user can, just as if they were right in front of it. For a Trojan to gain access to the computer system, the user may first be induced to install the Trojan. For example, this may be done through the offering of anything that a user might find desirable via email, instant messengers, or file sharing tools (i.e., free games, movies, system enhancements, etc.). A user may download a Trojan horse program that appears to be a calculator, performing the functions of a simple pocket calculator. When the user launches the infected file, it may appear to be performing calculations and nothing more. However, it may also be performing a number of harmful actions, such as deleting files, stealing passwords, adding files, disrupting system operation, etc. In addition, the Trojan horse may be an e-mail attachment disguised as a document file, readme file, etc. If a user launches the infected file, the Trojan may initiate installation procedures and/or propagation routines.

Trojan horse programs can be introduced to a computer system by initially being planted in publicly-accessible software repositories, such as software bulletin boards, publicly accessible directories, file-sharing systems, such as the KaZaA network, etc. Users accessing these repositories are then tricked into copying the Trojan horse program into their own computer systems. These users then can further spread the Trojan horse by sharing the infected program with other users, most especially if the program performs a useful function and causes no immediate or obvious damage.

In another example, users who are merely “surfing the Internet” may unwittingly introduce malicious software on their machines, for example, by downloading malicious software components embedded into web pages and/or various spyware products distributed at publicly-accessible web site.

Current Anti-Malware Solutions

Users may utilize anti-virus programs in order to protect their computer systems from security threats such as Trojan horses. Anti-virus programs operate to protect from the spread of viruses by detecting the virus and isolating or removing the viral code. Examples of anti-virus software may include activity monitoring programs, scanning programs, and/or integrity checking programs.

Activity monitoring programs attempt to prevent the infection of computer systems by searching for “virus-like” activity, such as, attempts to delete a file, or to write to an executable file, and may then attempt to prevent this activity from taking place. Virus scanning programs may contain a list of previously defined virus signatures, containing the binary patterns of a virus, each associated with a virus and scan the various files of a system looking for a match to a particular virus signature. If a virus is detected, the user may be notified and further steps may be taken to rid the system of the malicious code. Integrity checking programs compute a checksum value for all of the uninfected, executable files residing on the computer system and compare the computed checksum values to checksum values generated at a later time to determine if anything has changed in the file. If the checksums match, then the executable file is uninfected. However, if the checksums do not match, then the executable file may possibly be infected and steps may be taken to remove the infected file.

Anti-virus software programs may not provide a computer user with comprehensive protection against Trojans. For example, activity monitoring programs may not adequately prevent Trojan horses because it is hard for them to distinguish between a Trojan horse that, for example, is maliciously deleting a system's file, and a regular program that is supposed to delete a system's file. Virus scanning software may detect viruses present in the system, but it may do nothing to prevent them from infiltrating the system in the first place. The virus scanning software should be continuously updated in order to be effective in detecting new and modified Trojans. This not only proves to be a very tedious and time-consuming task for computer users, but also may not happen often enough to provide adequate safeguards against foreign intrusions. Integrity checking programs not only do not know which viruses they are in fact detecting; but in cases where a file has been legitimately modified, they may also require the user to verify whether or not the detected executable file contains a virus. There is a window of time between when a new attack is released to the public, and when anti-virus products have signatures to detect the attack. During this window of time, the attack is given the opportunity to do its damage. Therefore, just because a user has installed and is running an anti-virus program does not necessarily mean that the user's system is no longer vulnerable to security threats.

Thus, one shortcoming of anti-malware software that resides on a user machine is the need for the user to maintain the most “updated” version of the anti-virus software on her machine. Although many anti-virus packages try to automate this process, this is still a process that irritates many users and is prone to failure.

Towards this end, certain “appliance-based” products which reside on a machine other than that being protected are currently available. One example is the e-safe Secure Content Management (SCM) gateway from Aladdin Knowledge Systems. In order to protect an organization's machines from malware, network administrators thus deploy one or more appliances onto the organization's LAN (typically, behind a firewall) in order to provide “perimeter security services” to client machines without requiring installation of anti-malware software on each client machine.

While appliance-based solutions are exceptionally useful in many situations, for many users (for example, home users, small business users, etc) it may not be feasible to purchase, deploy and maintain content filtering devices in the home network and/or small business network. To date, these users either install “anti-virus” packages on their individual machines (which are often out of date), or make due without anti-virus protection.

Thus, there is an ongoing need for universality-available, easily accessible and affordable anti-malware protection.

### SUMMARY OF THE INVENTION

The present invention relates to apparatus and method for providing protection against suspected malicious code transmitted over a public networks such as the Internet.

The present inventor is disclosing, for the first time, a service that provides “secure surfing” over a network to multiple subscribing users, using a network-based security server cluster. In exemplary embodiments, the security server filter the users' network traffic and removes suspected unwanted or bad “malicious” code. In exemplary embodiments, the security server routes value-added content to the subscribed user.

Apparatus and methods for providing proxy and security services to one or more users via a publicly accessible network (e.g. the Internet) are disclosed herein. Upon receiving a user request for content residing a third-party location (for example, at a Web site), a security server(s) retrieves the requested content from the third-party location, and monitors the retrieved content for suspected malicious code, which may be removed from the retrieved content before serving to the user via the publicly accessible network According to exemplary embodiments, the security server(s) is further operative to route value-added content to the user, for example, value-added content retrieved from various network sources. In some embodiments, this value-added content is associated with the requested content from the third-party location, for example, embedded in a Web page together with the, optionally cleaned, retrieved content from the third-party location.

It is now disclosed for the first time a method of providing a security service to one or more user computers in a remote computer cluster. The presently-disclosed method includes the steps of: (a) receiving, at a remote security server cluster, a proxy request for third-party content at a third-party destination; (b) retrieving the requested third-party content from the third-party destination; and (c) monitoring the retrieved content for suspected malicious code.

As used herein, “malicious code” or malware includes but is not limited to both malicious code viruses, spyware. Trojan horses, and worms.

It is noted that the “remote computer cluster” is in communication with a security server over a publicly accessible network and/or wide-area network such as the Internet.

According to some embodiments, the presently-disclosed method further includes: d) obtaining content derived from the retrieved content; and e) serving the derived content to a remote user computer (i.e. one or more computers of the computer cluster).

According to some embodiments, the obtaining of the derived content includes removing at least some malicious code from the retrieved content.

According to some embodiments, the obtaining of the derived content includes: (i) providing value-added content (i.e. by retrieving the value-added content over the Internet and/or by providing value-added content generated and/or stored in the remote security server cluster); and ii) adding to the retrieved content (for example, embedding within the retrieve content and/or serving concomitantly with the retrieved content) at least one of the value-added content and a reference (for example, a link) to the value-added content.

Exemplary value-added content includes but is not limited to advertisements (e.g. targeted advertisements), sponsored links, additional content mark-up, etc. Although the presently-disclosed service may be provided to any user, in exemplary embodiments, the service is provide selectively to pre-registered and/or authenticated subscribed users.

According to some embodiments, the value-added content is provided in accordance with at least one of a subscriber attribute (i.e. demographic data for the subscriber), an attribute of a user computer (for example, a device type—i.e. PDA vs. microcomputer, an operating system type—for example, MAC owners could be served types of advertisements), contents of the retrieved content (thereby providing “context-based” advertisement), an attribute of a site of the third-party content (for example, category of the third-party web-site—for example, news sites, sports sites, etc), and a user subscription attribute (for example, pay vs. advertisement vs. trial subscription).

According to some embodiments, the method further includes: d) configuring a user device (i.e. in a user computer cluster that is “remote” to security server cluster) to route Internet traffic via the security server cluster. In one example, the browser and/or other web client residing on a computer of the user computer cluster is configured to relate to one or more machines of the security server cluster as a proxy server. In another example, a router of the user computer cluster is configured to route content requests and/or other traffic via the “proxy” security server cluster In some embodiments, a majority or all traffic for one or more user computers are routed via the proxy security server.

According to some embodiments, at least one of the following conditions is true: i) the proxy request is received from a user computer residing in the same virtual private network as the remote server cluster; ii) the method further comprises serving content derived from the retrieved content to a remote user computer residing in the same virtual private network as the remote server cluster.

It is now disclosed for the first time apparatus for providing security service to a remote user computer cluster comprising (a) a security server cluster (i.e. a cluster of one or more machines that provide security services and optionally, one or more additional services) operative to provide, via a wide-area network (typically, the Internet), remote security services to the user computer cluster (i.e. to at least one user computer of the user computer cluster), wherein: (i) the security server cluster is configured as a proxy to receive, via the wide-area network, content requests for third-party content (i.e. content residing at a third-party destination) and to retrieve (i.e. via the wide-area network, typically the Internet) die requested content from a third-party destination; and (ii) the remote security cluster is further operative to monitor at least some retrieved content for suspected malicious code.

According to some embodiments, the security server cluster is further operative to: iii) obtain content derived from the retrieved content; and iv) serve the derived content to a remote user computer (i.e. a user computer in communication with the security server cluster via the wide-area network).

According to some embodiments, the security cluster is configured such that the obtaining by the security cluster of the derived content includes removing at least some malicious code from the retrieved content.

According to some embodiments, the apparatus further includes b) a value-added content provider operative to provide value-added content, wherein the security cluster is configured such that the obtaining by the security cluster of the derived content includes adding to the retrieved content at least one of the value-added content and a reference to the value-added content.

According to some embodiments, the value-added content provider is operative to effect the providing in accordance with at least one of a subscriber attribute, an attribute of a user computer, contents of the retrieved content, an attribute of a site of the third-party content, and a user subscription attribute.

According to some embodiments, the security cluster is operative to communicate with the remote user computer cluster using a tunneling communications protocol.

It is now disclosed for the first time a computer readable medium comprising program instructions, wherein when executed the program instructions are operable to, in accordance with proxy request, received at a remote security server cluster, for third-party content at a third-party destination: a) retrieve the requested third-party content from the third-party destination; and b) monitor the retrieved content for suspected malicious code.

It is now disclosed for the first time a system for providing security comprising: (a) a user computer cluster; and (b) a remote security server cluster operative to provide security services to the user computer cluster, the user computer cluster and the remote security server cluster being in communication via a wide-area network (typically, the Internet) wherein: i) the remote security cluster is configured as a proxy to receive content requests for third-party content (i.e. content residing at a third-party destination) and to retrieve the requested content from a third-party destination; and ii) the remote security cluster is further operative monitor at least some retrieved content for suspected malicious code.

According to some embodiments, at least one of the following conditions are true: i) the user computer cluster and the server computer cluster reside within a single virtual private network (VPN); and ii) the user computer cluster and the server computer clusters are operative to communicate using a tunneling protocol.

According to some embodiments, the remote security cluster and the user computer cluster are operative to communicate using at least one protocol selected from the group consisting of point-to-point (PPP), point-to-point tunneling protocol (PPTP), Layer 2 Tuneling Protocol (L2TP), Isp, SSL, and L2F.

According to some embodiments, the remote security server cluster includes an authentication mechanism and the remote security server cluster is operative to effect at least one of the content retrieving and the content monitoring only after authentication by the authentication mechanism.

According to some embodiments, the remote security cluster is operative to remove at least some suspected malicious code from the retrieved content.

According to some embodiments, the remote server is operative to handle at least content request type selected from the group consisting of a HTTP requests, web service content requests, file download requests, and peer-to-peer (P2P_ content requests.

According to some embodiments, the remote server is operative to handle a plurality of the content request types.

According to some embodiments, the remote security cluster is further operative to effect a content serving decision in accordance with results of the monitoring.

According to some embodiments, the content serving decision is selected from the group consisting of a decision to filter content, a decision to serve warning content, and a decision to not serve any content derived from the retrieved content.

According to some embodiments, the remote security cluster is configured to receive the requests from the user computer cluster.

According to some embodiments, the user computer cluster is configured to issue proxy requests for the third-party content to the remote security server cluster.

According to some embodiments, the user computer and the security server are operative to communicate using a connection-oriented communications protocol.

According to some embodiments, the user computer and the security server are operative to communicate using a connectionless communications protocol.

According to some embodiments, the security server is operative to associate value-added content with and/or embed the value-added content (or a reference to the value-added content) into the monitored content.

According to some embodiments, the associating includes: i) retrieving the value added content via a wide-area network; and ii) associated the retrieve content with the monitored content.

It is now disclosed for the first time a method of doing business comprising: a) registering a user for a remote-proxy-and-malicious-content monitoring service (for example, providing an web-based and/or an email-based registration system), the registering including offering to the user at least one subscription option; b) providing the remote-proxy-and-malicious code monitoring service (i.e. a service where a server is deployed to act as a proxy server for a user computer and to also monitor retrieved content for suspected malicious code) to the registered user; and c) if the registered user is an advertisement-supported user (i.e. a user who elected to receive advertisements with proxy-retrieved web content), routing value-added content (for example, by embedding an advertisement and/or a reference or link to value-added content) to the registered user concomitant with (i.e. associated with proxy-retrieved content) the providing of the service.

According to some embodiments, the at least one subscription option includes a pay option.

According to some embodiments, the at least one subscription option includes an option for an advertisement-supported service

According to some embodiments, if the registered user is a pay-subscriber, the service is provided without concomitantly routing advertisements associated with proxy-retrieved content to the pay-subscriber.

These and further embodiments will be apparent from the detailed description and examples that follow.

### BRIEF DESCRIPTION OF THE DRAWINGS

FIG. 1A provides a block diagram of an exemplary system for providing proxy and security services.

FIG. 1B provides a block diagram of an exemplary method for providing proxy and security services.

While the invention is described herein by way of example for several embodiments and illustrative drawings, those skilled in the art will recognize that the invention is not limited to the embodiments or drawings described. It should be understood that the drawings and detailed description thereto are not intended to limit the invention to the particular form disclosed, but on the contrary, the invention is to cover all modifications, equivalents and alternatives falling within the spirit and scope of the present invention. As used throughout this application, the word “may” is used in a permissive sense (i.e., meaning “having the potential to’), rather than the mandatory sense (i.e. meaning “must”).

### DETAILED DESCRIPTION OF EMBODIMENTS

The present invention will now be described in terms of specific, example embodiments. It is to be understood that the invention is not limited to the example embodiments disclosed. It should also be understood that not every feature of the presently disclosed apparatus, device and computer-readable code for providing security services is necessary to implement the invention as claimed in any particular one of the appended claims. Various elements and features of devices are described to fully enable the invention. It should also be understood that throughout this disclosure, where a process or method is shown or described, the steps of the method may be performed in any order or simultaneously, unless it is clear from the context that one step depends on another being performed first.

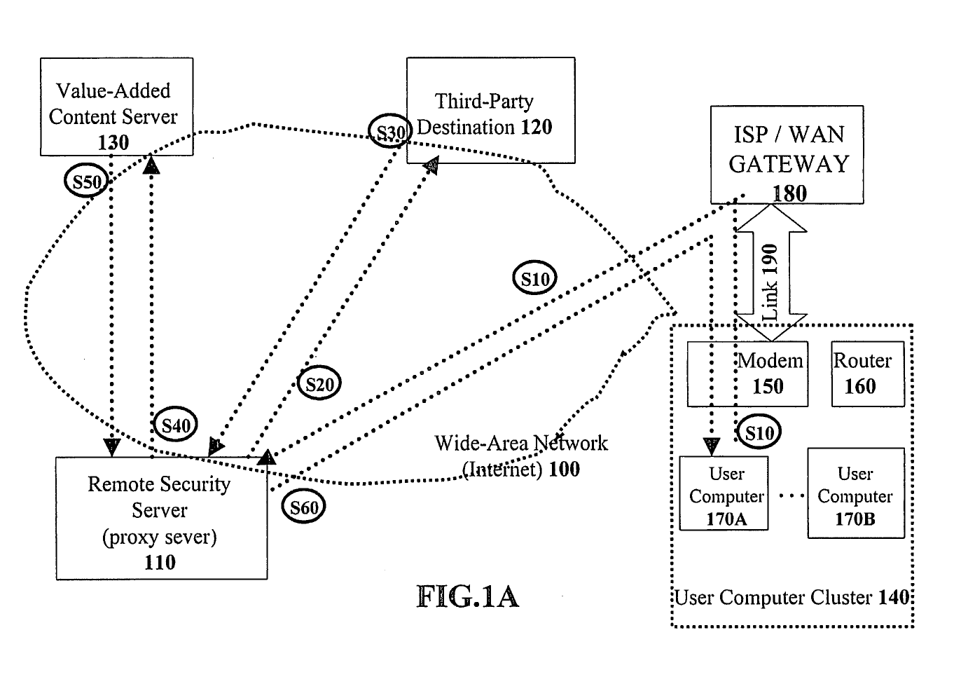

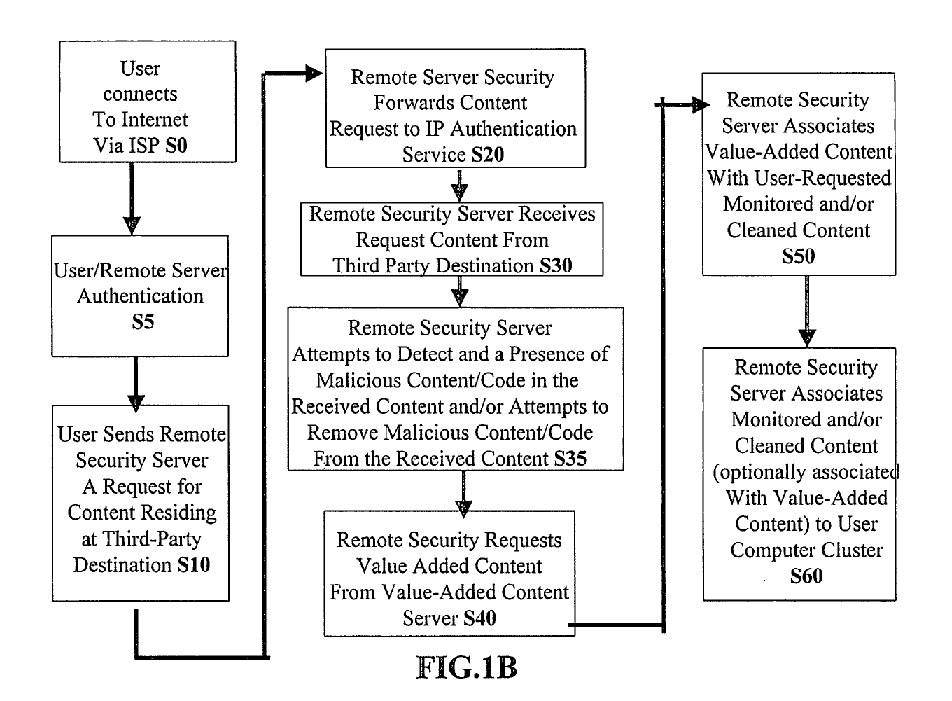

FIG. 1A-1B provides a block diagram of an exemplary system and exemplary method for providing security according to exemplary embodiments of the present invention. The system includes a remote security server 110 and a user computer cluster 140 which are in communication with each other through a wide-area network 100 (typically, public networking infrastructure such as the Internet). In the example of FIG. 1, one or more individual user computers 170 (for example, a “user-accessing” device such as a desktop or notebook microcomputer, or a PDA, or a cell phone) of the user computer cluster 140 are connected to the wide-array network 100 through a link 190 (for example, a broadband link, dialup link, SOHO link or any other ISP-access link, or a cellphone internet access link for surfing with the cellular device) with a WAN gateway 180 provided by an ISP (an ISP access point). The remote security server 110 (or cluster of servers) provides security services for one or more of the user computers 170 within the user computer cluster 140 for content accessed from a third-party destination 120.

As used herein, a “remote” server is a device or plurality of devices (for example, a cluster, for example, including load-balancing functionality) that is operative and/or deployed to communicate with one or more user computer clusters 140 via a wide-area network 100. As used herein, a “security cluster” includes one or more machines.

After connecting S0 to the internet via the ISP/WAN Gateway 180 (using any connection link 190 known in the art, including but not limited to dial-up, DSL, cable modem, etc), a machine of the user computer cluster 140 sends S10 (via the wide-area network 100) to the remote security server 110 a request for content residing at a third-party destination 120 (for example, any Internet “web site”). It is appreciated that there is no limitation of a single third-party destination 120, and that typically the remote security server 110 is operative to cooperate with a plurality of third-party destinations.

Furthermore, although the remote security server 110 is illustrated in FIG. 1A as a single device, this is not a limitation, and in exemplary embodiments, the remote security server 110 is provided as a cluster of devices, for example, a cluster residing in a LAN and/or a cluster distributed in various locations of the WAN 100.

Optionally, before or concomitant with issuing S10 the content request, the machine of the user computer cluster 140 (the “client device”, typically user computer 170) will effect S5 some sort of authentication with the remote security server 110. In different examples, this could include effecting a mutual authentication, opening an SSL connection, etc. This may be useful, for example, to protect the security server 110 from a man-in-the-middle attack, or from various other operations that a cracker may take to compromise the security and/or privacy of the security server 110. Furthermore, in many scenarios, the security server 110 is configured to provide security services (i.e. detection and/or cleaning of malicious code) only to some machines that access the security server 110, and authentication may be useful so that the security server 110 only provides security services to “allowed” users.

There is no explicit limitation on what client application issues the content request S10. In exemplary embodiments, this request is issued by a web browser, for example, a web browser configured to relate to the security server as a proxy server 110. Alternatively, a web client other than a web browser may issue this request. In one particular example, the request for content is issued as a “web service request” for a web service provided by the third-party destination 120.

In another example, a device (for example, in the user computer cluster 140) other than the user computer 140 is configured to re-route content requests via the remote security server 110. In one example, a modem or router may re-route request for content from a third-party destination 120 to the remote security server 110.

After receiving the content request, the remote security server forwards and/or issues S20 a content request to the third-party destination 120, and receives (directly or indirectly) the request content from the third-party destination 120.

Typically, the third-party destination 120 does not reside in the same LAN(s) as the remote security server cluster 110, and content request S20 is sent over the wide-area network 100 to a different location(s)/LAN(s) in the wide-area network(s) 100.

Remove security server 110 is operative to monitor S35 the content received in step S30 for the presence of and/or absence of suspected malicious code or suspected “malware”.

In one example, some or all of suspected malware is removed from the retrieved content produce “cleaned content” which is then served S60 to the user computer cluster 140. Alternatively or additionally, if a presence of malicious code is suspected, a warning message is sent to the user computer cluster 140 and/or associated with the content that is served S60 to the computer cluster. Alternatively or additionally, the remote security server 100 will not send S60 the retrieved content suspected of including malicious code to the user computer cluster 140.

The detecting of malicious code is well known in the art, and may be carried out according to any-known technique. The “detecting” of suspected malicious code also includes detecting an increase likelihood that monitored content includes malicious code. In one example, there are a plurality of possible features of malicious code, and detected one feature indicative of malicious code (even if, it turns out, the content is not, in fact, malicious) is also within the scope of monitoring for and/or attempting to detect “malicious code.”

In yet another example, the remote security server 110 will “prompt” the user computer cluster 140 before sending S60 the request monitored and/or cleaned content.

In yet another example, the remote security server is configurable to provide any combination of the aforementioned options, for example, in accordance with user preferences, a characteristic of a user and/or the user computer cluster 140 (for example, an operating system of a machine of the user computer cluster 140), the type of malicious code detected, a severity of malicious code detected, recent “malware” warnings, etc.

In exemplary embodiments, one or more steps are carried out in real time.

Value-Added Content

In exemplary embodiments, the remote security server 110 is operative to optionally associate the handled content (i.e. the monitored and/or cleaned content which is served 60 to the user computer cluster 140) with “value added content,” for example, informative messages such as advertisements. In exemplary embodiments, the value-added content may be provided in accordance with one or more factors, for example, in accordance with (1) the monitored and/or cleaned content, (2) an attribute and/or identity of the user (for example, a user-ID, a geographic location, a classification of content historically accessed by the user, a user demographic, etc), (3) an attribute and/or identity of the third-party destination 120 (for example, the specific web-site Url, a classification of the web-site, etc).

The routine in FIG. 1B includes the steps of requesting value added content S40 and associating value-added content S50 with monitored and/or cleaned user-requested content. It is noted that the order of steps in FIG. 1B is not intended as limiting—for example, the value-added content may be received before monitoring and/or removing S35 malicious code, etc.

Furthermore, the network architecture described in FIG. 1A is also not intended as limiting. For example, the optional value-added content server 130 need not be in communication with the remote security server 110 via the WAN 100 as illustrated in FIG. 1A. In some embodiments, the optional value-added content server 130 is located in the same LAN as the remote security server 110 and/or resides in the same machine as the remote security server 110.

Types of User-Request Content

The term “content” (i.e. requested by the user computer cluster 140 in S10) includes but is not limited to web pages, email content, file content (for example, file downloads and email attachment), and streaming content (for example, a streaming media file, for example, streaming Voice/IP content, for example, streaming live video content). In one example, a user receives streaming audio and/or video content from the third party destination 120 via the remote security server 110 to the user computer cluster 140. Thus, in exemplary embodiments, the remote security server 110 is operative to monitor and/or clean multiple types of traffic.

Communication Between the User Computer Cluster and the Remote Security Server

As illustrated in FIG. 1A, traffic between the remote security server 110 and the user computer cluster 140 is sent via a communication link that includes the ISP/WAN gateway 180.

There is no explicit limitation on the communication protocol between the proxy server 110 and the user computer cluster 140. Nevertheless, as noted earlier, there are many situations where it is desired to protect the traffic between the security server 110 and the user computer cluster 140, which traverses the (typically public) wide-area network 100.

Towards this end, in exemplary embodiments, communications between the user computer cluster 140 and the remote security server 110 may include encrypted communications.

In exemplary embodiments, the user computer cluster 140 and the remote security server 110 may reside in the same virtual private network (VPN), for example, as different VPN “islands” at different locations of the public network 100. Any VPN is in the scope of the present invention, including secure VPNs and trusted VPNs.

Thus, it is noted that the security server may be operative to communicate with the user computer cluster 140 using a “secure” communications protocol, including but not limited VPN protocols and pseudo-VPN protocol. Furthermore, it is noted that tunneling communications protocols are also within the scope of the present invention.

Exemplary protocols for remote security server 110—user computer cluster 140 communication include but are not limited to IPSec, SS1, PPTP, L2TP, L2TPv3, and L2F.

Registration

Although not an explicit requirement, in exemplary embodiments the user pre-registers for the service using one or more subscription option. For example, the user is given the option to select a pay subscription, a free subscription, a partially or whole advertisement subscription or any combination thereof.

In exemplary embodiments, the subscription is offered and/or advertised as a free or ad-supported service.

In the description and claims of the present application, each of the verbs, “comprise” “include” and “have”, and conjugates thereof, are used to indicate that the object or objects of the verb are not necessarily a complete listing of members, components, elements or parts of the subject or subjects of the verb.

All references cited herein are incorporated by reference in their entirety. Citation of a reference does not constitute an admission that the reference is prior art.

The articles “a” and “an” are used herein to refer to one or to more than one (i.e., to at least one) of the grammatical object of the article. By way of example, “an element” means one element or more than one element.

The term “including” is used herein to mean, and is used interchangeably with, the phrase “including but not limited” to.

The term “or” is used herein to mean, and is used interchangeably with, the term “and/or,” unless context clearly indicates otherwise. The term “such as” is used herein to mean, and is used interchangeably, with the phrase “such as but not limited to”.

The present invention has been described using detailed descriptions of embodiments thereof that are provided by way of example and are not intended to limit the scope of the invention. The described embodiments comprise different features, not all of which are required in all embodiments of the invention. Some embodiments of the present invention utilize only some of the features or possible combinations of the features. Variations of embodiments of the present invention that are described and embodiments of the present invention comprising different combinations of features noted in the described embodiments will occur to persons of the art.

What is claimed is:

1) A method of providing a security service to one or more user computers in a remote computer cluster, the method comprising:
a) receiving, at a remote security server cluster, a proxy request for third-party content at a third-party destination;
b) retrieving said requested third-party content from said third-party destination; and
c) monitoring said retrieved content for suspected malicious code.

2) The method of claim 1 further comprising:
d) obtaining content derived from said retrieved content;
e) serving said derived content to a remote user computer.

3) The method of claim 2 wherein said obtaining of said derived content includes removing at least some said suspected malicious code from said retrieved content.

4) The method of claim 2 wherein said obtaining of said derived content includes:
i) providing value-added content;
ii) adding to said retrieved content at least one of said value-added content and a reference to said value-added content.

5) The method of claim 4 wherein said value-added content is provided in accordance with at least one of a subscriber attribute, an attribute of a user computer, contents of said retrieved content, an attribute of a site of said third-party content, and a user subscription attribute.

6) The method of claim 1 further comprising:
d) configuring a user device to route Internet traffic via said security server cluster.

7) The method of claim 1 wherein at least one of the following conditions is true:
i) said proxy request is received from a user computer residing in the same virtual private network as said remote server cluster;
ii) the method further comprises serving content derived from said retrieved content to a remote user computer residing in the same virtual private network as said remote server cluster.

8) Apparatus for providing security service to a remote user computer cluster comprising:
a) a security server cluster operative to provide, via a wide-area network, remote security services to the user computer cluster, wherein:
i) said security server cluster is configured as a proxy to receive, via said wide-area network, content requests for third-party content and to retrieve said requested content from a third-party destination; and
ii) said remote security cluster is further operative to monitor at least some said retrieved content for suspected malicious code.

9) Apparatus of claim 8 wherein said security server cluster is further operative to:
iii) obtaining content derived from said retrieved content; and
iv) serving said derived content to a remote user computer.

10) Apparatus of claim 8 wherein said security cluster is configured such that said obtaining by said security cluster of said derived content includes removing at least some said malicious code from said retrieved content.

11) Apparatus of claim 8 further comprising:
b) a value-added content provider operative to provide value-added content, wherein said security cluster is configured such that said obtaining by said security cluster of said derived content includes adding to said retrieved content at least one of said value-added content and a reference to said value-added content.

12) Apparatus of claim 11 wherein said value-added content provider is operative to effect said providing in accordance with at least one of a subscriber attribute, an attribute of a user computer, contents of said retrieved content, an attribute of a site of said third-party content, and a user subscription attribute.

13) Apparatus of claim 12 wherein said security cluster is operative to communicate with the remote user computer cluster using a tunneling communications protocol.

14) A computer readable medium comprising program instructions, wherein when executed the program instructions are operable to, in accordance with proxy request, received at a remote security server cluster, for third-party content at a third-party destination:
a) retrieve said requested third-party content from said third-party destination; and
b) monitor said retrieved content for suspected malicious code.

15) A system for providing security comprising:
a) a user computer cluster; and
b) a remote security server cluster operative to provide security services to said user computer cluster, said user computer cluster and said remote security server cluster being in communication via a wide-area network, wherein:
i) said remote security cluster is configured as a proxy to receive content requests for third-party content and to retrieve said requested content from a third-party destination; and
ii) said remote security cluster is further operative monitor at least some said retrieved content for suspected malicious code.

16) The system of claim 15 wherein at least one of the following conditions are true:
i) said user computer cluster and said server computer cluster reside within a single virtual private network (VPN);
ii) said user computer cluster and said server computer clusters are operative to communicate using a tunneling protocol.

17) The system of claim 1 wherein said remote security server cluster includes an authentication mechanism and said remote security server cluster is operative to effect at least one of said content retrieving and said content monitoring only after authentication by said authentication mechanism.

18) The system of claim 15 wherein said remote security cluster is operative to remove at least some said suspected malicious code from said retrieved content.

19) The system of claim 15 wherein said remote server is operative to handle at least content request type selected from the group consisting of a HTTP requests, web service content requests, file download requests, and P2P content requests.

20) The system of claim 15 wherein said remote server is operative to handle a plurality of said content request types.

21) The system of claim 15 wherein said remote security cluster is further operative to effect a content serving decision in accordance with results of said monitoring.

22) The system of claim 21 wherein said content serving decision is selected from the group consisting of a decision to filter content, a decision to serve warning content, and a decision to not serve any content derived from said retrieved content.

23) A method of doing business comprising:
a) registering a user for a remote-proxy-and-malicious-content monitoring service, said registering including offering to said user at least one subscription option;
b) providing said remote-proxy-and-malicious code monitoring service to said registered user; and
c) if said registered user is an advertisement-supported user, routing value-added content to said registered user concomitant with said providing of said service.

24) The method of claim 23 wherein at least one said subscription option is a pay subscription option.

25) The method of claim 23 wherein at least one said subscription option is an option for an advertisement-supported service

26) The method of claim 25 wherein if said registered user is a pay-subscriber, said service is provided without concomitantly routing advertisements associated with proxy-retrieved content to said pay-subscriber.
